(19) United States
(12) Patent Application Publication
(10) Pub. No.: US 2023/0150815 A1
(43) Pub. Date: May 18, 2023

(54) HYDROGEN REFORMING SYSTEM

(71) Applicants: Hyundai Motor Company, Seoul (KR); Kia Corporation, Seoul (KR)

(72) Inventors: Ji Hye Park, Seoul (KR); Seung Hyeon Choi, Seoul (KR)

(21) Appl. No.: 17/844,945

(22) Filed: Jun. 21, 2022

(30) Foreign Application Priority Data
Nov. 12, 2021 (KR) 10-2021-0155922

(51) Int. Cl. C01B 3/34; C01B 3/56

(52) U.S. Cl. CPC C01B 3/34; C01B 3/56; C01B 2203/043; C01B 2203/82; C01B 2203/84; C01B 2203/0233; C01B 2203/0485; C01B 2203/0833; C01B 2203/0883

(57) ABSTRACT

The present disclosure relates to a hydrogen reforming system including a reforming part configured to extract hydrogen from a source gas, and a metal hydride compressor configured to be operated by waste heat discharged from the reforming part and to compress the hydrogen discharged from the reforming part, thereby obtaining an advantageous effect of combining the function of two machines and improving energy efficiency.

### CROSS-REFERENCE TO RELATED APPLICATION

This application claims under 35 U.S.C. §119(a) the benefit of Korean Patent Application No. 10-2021-0155922 filed on Nov. 12, 2021, the entire contents of which are incorporated herein by reference.

### BACKGROUND

### (A) Technical Field

The present disclosure relates to a hydrogen reforming system, and more particularly, to a hydrogen reforming system capable of simplifying a structure and improving energy efficiency.

### (B) Description of Related Art

Technologies using hydrogen as an energy source have been developed in various fields because the hydrogen is economical, environmentally friendly, and capable of being regenerated.

Hydrogen may be produced by fossil fuel-based methods such as steam reforming, coal gasification, water electrolysis, biomass gasification, and other thermochemical processes.

Steam reforming is being widely used because the steam reforming is less restricted in raw material and produces a larger amount of hydrogen in comparison with other methods.

Steam reforming may extract hydrogen from a source gas through a process of desulfurizing a source gas (e.g., town gas), a process of reforming the source gas, or a pressure swing adsorption (PSA) process.

However, hydrogen extracted through the steam reforming process has a low pressure (e.g., 10 bar or less), which makes it difficult to immediately store such hydrogen in a storage facility such as a high-pressure tank.

For this reason, in the related art, a separate compressor (e.g., a mechanical compressor such as a piston compressor) needs to be used to store the hydrogen extracted through the steam reforming process in the high-pressure storage facility.

However, such compressors need to be provided separately from the steam reforming system, which complicates a structure and degrades a degree of design freedom and spatial utilization.

Accordingly, there is a need to develop a technology to extract high-pressure hydrogen directly from a hydrogen reforming system.

### SUMMARY

Example embodiments of this disclosure are directed to a hydrogen reforming system including (i) a reforming part configured to extract hydrogen from a source gas; and (ii) a metal hydride compressor configured to be operated by waste heat discharged from the reforming part and to compress the hydrogen discharged from the reforming part.

In some embodiment(s), the present disclosure is directed to a method of operating a metal hydride compressor by using waste heat discharged from a reforming part without additionally providing a separate heat source for operating the metal hydride compressor.

Preferred embodiments of the hydrogen reforming system of the present disclosure may minimize electric power consumption and improve energy efficiency over existing technologies.

Preferred embodiments of the hydrogen reforming system of the present disclosure may simplify the structure of existing technologies and may improve a degree of design freedom and spatial utilization over existing technologies.

The objects to be achieved by exemplary embodiments disclosed herein are not limited to the above-mentioned objects, but also include objects or effects that may be understood from the solutions or exemplary embodiments described below.

An exemplary embodiment of the present disclosure provides a hydrogen reforming system including a reforming part configured to extract hydrogen from a source gas, and a metal hydride compressor configured to be operated by waste heat discharged from the reforming part and compress the hydrogen discharged from the reforming part.

Preferred embodiments of the hydrogen reforming system of the present disclosure may aim to simplify the structure of existing technologies and may improve energy efficiency of the hydrogen reforming system over existing technologies. In currently existing technologies, a separate compressor (e.g., a mechanical compressor) needs to be additionally provided to store the hydrogen extracted (produced) through the steam reforming process in the high-pressure storage facility, which complicates the structure and degrades the degree of design freedom and spatial utilization.

However, according to the exemplary embodiments of the present disclosure, the metal hydride compressor may be operated by the waste heat discharged from the reforming part that extracts the hydrogen from the source gas. Therefore, in example of the present disclosure, it is possible to extract the high-pressure hydrogen directly from the hydrogen reforming system and store the extracted hydrogen in the high-pressure storage facility without additionally providing a separate compressor (e.g., a mechanical compressor) for storing the hydrogen in the high-pressure storage facility.

Moreover, according to some exemplary embodiments of the present disclosure, it is possible to operate the metal hydride compressor (compress the hydrogen) without additionally providing a separate heat source for operating the metal hydride compressor. Therefore, some exemplary embodiments allow for an advantageous effect of simplifying the structure, improving the degree of design freedom and spatial utilization, minimizing electric power consumption, and/or improving the energy efficiency.

The reforming part may have various structures capable of extracting the hydrogen from the source gas.

According to exemplary embodiments of the present disclosure, the reforming part may include: a reformer configured to produce a target gas containing the hydrogen by allowing a source gas to react with water; a burner configured to apply heat to the reformer; and a pressure swing adsorption (PSA) unit configured to separate the hydrogen from the target gas discharged from the reformer, and the metal hydride compressor may be operated by heat of an exhaust gas discharged from the burner.

For example, the hydrogen reforming system may include an exhaust gas discharge line configured to discharge the exhaust gas generated by combusting fuel in the burner, and an exhaust gas guide line connected to the exhaust gas discharge line and configured to guide the exhaust gas to the metal hydride compressor. The exhaust gas supplied along the exhaust gas guide line may be used as a heat medium for heating the metal hydride compressor.

The metal hydride compressor may have various structures capable of compressing the hydrogen.

According to exemplary embodiments of the present disclosure, the metal hydride compressor may include a first compressor configured to compress the hydrogen and disposed in a first branch line branching off from a hydrogen discharge line through which the hydrogen is discharged from the reforming part (a hydrogen discharge line connected to the PSA unit), and a second compressor configured to compress the hydrogen alternately with the first compressor and disposed in a second branch line branching off from the hydrogen discharge line and connected in parallel with the first branch line.

As described above, the first compressor and the second compressor may be connected in parallel with each other, and the first compressor and the second compressor may alternately compress the hydrogen, which makes it possible to continuously perform the process of compressing the hydrogen without interruption. According to other exemplary embodiments of the present disclosure, three or more compressors may be used to constitute the metal hydride compressor. The present disclosure is not restricted or limited by the number of compressors and the arrangement structure of the compressors. Alternatively, only the single metal hydride compressor may be provided, and the process of compressing hydrogen may be intermittently performed.

According to exemplary embodiments of the present disclosure, the hydrogen reforming system may include a heater disposed in a source gas supply line for supplying the source gas to the reformer and configured to heat the source gas. The exhaust gas discharge line may pass through the heater, and the exhaust gas may be used as a heat medium for the heater.

According to exemplary embodiments of the present disclosure, since the exhaust gas discharge line passes through the heater as described above, the exhaust gas may be used as the heat medium for the heater. Therefore, exemplary embodiments of the present disclosure may have the advantage of minimizing consumption of the electric power of the heater for heating the source gas and improving the energy efficiency.

According to exemplary embodiments of the present disclosure, the hydrogen reforming system may include a desulfurizer disposed in the source gas supply line and positioned at an upstream side from the heater.

According to exemplary embodiments of the present disclosure, the hydrogen reforming system may include an air supply line configured to supply air to the burner, and an air heat exchanger disposed in the exhaust gas discharge line and may be configured to allow the exhaust gas and the air to exchange heat with each other.

Since, in exemplary embodiments, the air supplied along the air supply line exchanges heat with the exhaust gas as described above, the air to be supplied to the burner may be heated. Therefore, exemplary embodiments of the present disclosure may have the advantage of further improving the efficiency and performance of the burner.

According to exemplary embodiments of the present disclosure, the reforming part may include: a reformer configured to produce a target gas containing the hydrogen by allowing the source gas to react with water; a burner configured to apply heat to the reformer; a target gas discharge line configured to discharge the target gas from the reformer; a pressure swing adsorption (PSA) unit connected to the target gas discharge line and configured to separate the hydrogen from the target gas; and a heat exchanger disposed in the target gas discharge line to allow a coolant to flow and configured to allow the target gas and the coolant (e.g., water) to exchange heat with each other, and the metal hydride compressor may be operated by heat of the coolant having passed through the heat exchanger.

For example, the hydrogen reforming system may include a coolant guide line connected to the heat exchanger and configured to guide the coolant having passed through the heat exchanger to the metal hydride compressor. The coolant supplied along the coolant guide line may be used as a heat medium for heating the metal hydride compressor.

### BRIEF DESCRIPTION OF THE DRAWINGS

The above and other objects, features and advantages of embodiments of the present disclosure will be more apparent from the following detailed description taken in conjunction with the accompanying drawings.

FIG. 1 is a view for explaining a hydrogen reforming system according to an example embodiment of the present disclosure.

FIG. 2 is a view of a metal hydride compressor of the hydrogen reforming system in which the hydrogen is supplied to the second compressor while the first compressor compresses the hydrogen according to an example embodiment of the present disclosure.

FIG. 3 is a view of a metal hydride compressor of the hydrogen reforming system according to an example embodiment of the present disclosure.

FIG. 4 is a view for explaining a hydrogen reforming system according to an example embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C. As used herein, the singular forms “a,” “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

The present disclosure provides a hydrogen reforming system having a simplified structure and which is capable of improving energy efficiency. The hydrogen reforming system of example embodiments disclosed herein extracts high-pressure hydrogen directly from a hydrogen reforming system.

The present disclosure has also been made in an effort to minimize electric power consumption and improve energy efficiency.

The present disclosure has also been made in an effort to simplify a structure and improve a degree of design freedom and spatial utilization.

The objects to be achieved by the example embodiments are not limited to the above-mentioned objects, but also include objects or effects that may be understood from the solutions or embodiments described below.

An exemplary embodiment of the present disclosure provides a hydrogen reforming system including a reforming part configured to extract hydrogen from a source gas, and a metal hydride compressor configured to be operated by waste heat discharged from the reforming part and compress the hydrogen discharged from the reforming part.

This allows for a simplified structure and improves energy efficiency of the hydrogen reforming system. That is, in the related art, a separate compressor (e.g., a mechanical compressor) needs to be additionally provided to store the hydrogen extracted (produced) through the steam reforming process in the high-pressure storage facility, which complicates the structure and degrades the degree of design freedom and spatial utilization.

However, according to an example embodiment of the present disclosure, the metal hydride compressor may be operated by the waste heat discharged from the reforming part that extracts the hydrogen from the source gas. Therefore, it is possible to extract the high-pressure hydrogen directly from the hydrogen reforming system and store the extracted hydrogen in the high-pressure storage facility without additionally providing a separate compressor (e.g., a mechanical compressor) for storing the hydrogen in the high-pressure storage facility.

Moreover, according to an example embodiment of the present disclosure, it is possible to operate the metal hydride compressor (compress the hydrogen) without additionally providing a separate heat source for operating the metal hydride compressor. Therefore, it is possible to obtain an advantageous effect of simplifying the structure, improving the degree of design freedom and spatial utilization, minimizing electric power consumption, and improving the energy efficiency. The reforming part may include various structures capable of extracting the hydrogen from the source gas.

According to an exemplary embodiment of the present disclosure, the reforming part may include: a reformer configured to produce a target gas containing the hydrogen by allowing the source gas to react with water; a burner configured to apply heat to the reformer; and a pressure swing adsorption (PSA) unit configured to separate the hydrogen from the target gas discharged from the reformer, and the metal hydride compressor may be operated by heat of an exhaust gas discharged from the burner.

For example, the hydrogen reforming system may include an exhaust gas discharge line configured to discharge the exhaust gas generated by combusting fuel in the burner, and an exhaust gas guide line connected to the exhaust gas discharge line and configured to guide the exhaust gas to the metal hydride compressor. The exhaust gas supplied along the exhaust gas guide line may be used as a heat medium for heating the metal hydride compressor.

The metal hydride compressor may include various structures capable of compressing the hydrogen.

According to an exemplary embodiment of the present disclosure, the metal hydride compressor may include a first compressor configured to compress the hydrogen and disposed in a first branch line branching off from a hydrogen discharge line through which the hydrogen is discharged from the reforming part (a hydrogen discharge line connected to the PSA unit), and a second compressor configured to compress the hydrogen alternately with the first compressor and disposed in a second branch line branching off from the hydrogen discharge line and connected in parallel with the first branch line.

As described above, the first compressor and the second compressor may be connected in parallel with each other, and the first compressor and the second compressor may alternately compress the hydrogen, which makes it possible to continuously perform the process of compressing the hydrogen without interruption. According to another example embodiment of the present disclosure, three or more compressors may be used to constitute the metal hydride compressor. The present disclosure is not restricted or limited by the number of compressors and the arrangement structure of the compressors. Alternatively, only the single metal hydride compressor may be provided, and the process of compressing hydrogen may be intermittently performed.

According to an exemplary embodiment of the present disclosure, the hydrogen reforming system may include a heater disposed in a source gas supply line for supplying the source gas to the reformer and configured to heat the source gas. The exhaust gas discharge line may pass through the heater, and the exhaust gas may be used as a heat medium for the heater.

Since the exhaust gas discharge line passes through the heater as described above, the exhaust gas may be used as the heat medium for the heater. Therefore, it is possible to obtain an advantageous effect of minimizing consumption of the electric power of the heater for heating the source gas and improving the energy efficiency.

According to an exemplary embodiment of the present disclosure, the hydrogen reforming system may include a desulfurizer disposed in the source gas supply line and positioned at an upstream side from the heater.

According to an exemplary embodiment of the present disclosure, the hydrogen reforming system may include an air supply line configured to supply air to the burner, and an air heat exchanger disposed in the exhaust gas discharge line and configured to allow the exhaust gas and the air to exchange heat with each other.

Since the air supplied along the air supply line exchanges heat with the exhaust gas as described above, the air to be supplied to the burner may be heated. Therefore, it is possible to obtain an advantageous effect of further improving the efficiency and performance of the burner.

According to an exemplary embodiment of the present disclosure, the reforming part may include: a reformer configured to produce a target gas containing the hydrogen by allowing the source gas to react with water; a burner configured to apply heat to the reformer; a target gas discharge line configured to discharge the target gas from the reformer; a pressure swing adsorption (PSA) unit connected to the target gas discharge line and configured to separate the hydrogen from the target gas; and a heat exchanger disposed in the target gas discharge line to allow a coolant to flow and configured to allow the target gas and the coolant (e.g., water) to exchange heat with each other, and the metal hydride compressor may be operated by heat of the coolant having passed through the heat exchanger.

For example, the hydrogen reforming system may include a coolant guide line connected to the heat exchanger and configured to guide the coolant having passed through the heat exchanger to the metal hydride compressor. The coolant supplied along the coolant guide line may be used as a heat medium for heating the metal hydride compressor.

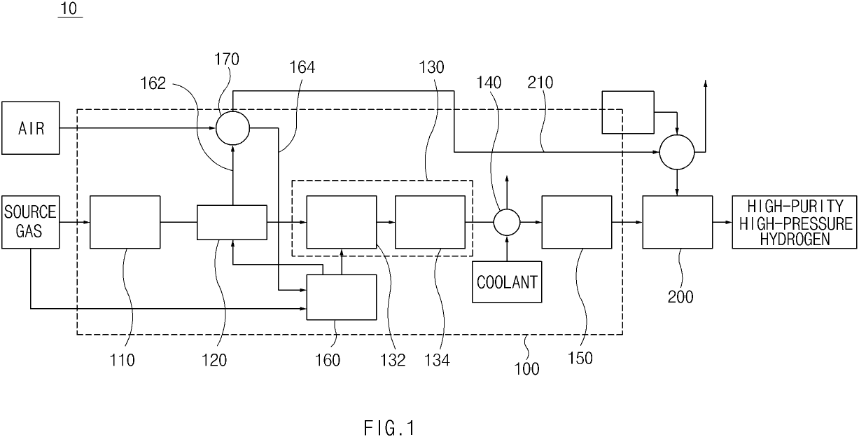

Referring to FIGS. 1 to 3, a hydrogen reforming system 10 according to an example embodiment of the present disclosure includes a reforming part 100 configured to extract hydrogen from a source gas, and a metal hydride compressor 200 configured to be operated by waste heat discharged from the reforming part 100 and compress the hydrogen discharged from the reforming part 100.

The reforming part 100 extracts hydrogen from the source gas.

For reference, in an example embodiment of the present disclosure, the source gas may be understood as a raw material used to produce hydrogen.

Various gases (or liquids) from which hydrogen may be extracted may be used as the source gas. The present disclosure is not restricted or limited by the type and properties of the source gas.

For example, a town gas (e.g., liquefied natural gas (LNG) or liquefied petroleum gas (LPG)), which is supplied to general houses, may be used as the source gas. Hereinafter, an example will be described in which LNG is used as the source gas.

The reforming part 100 may have various structures capable of extracting hydrogen from the source gas based on steam reforming. The present disclosure is not restricted or limited by the type and structure of the reforming part 100.

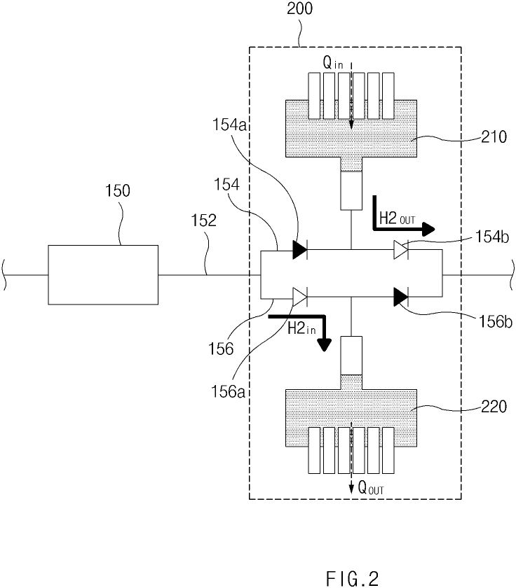

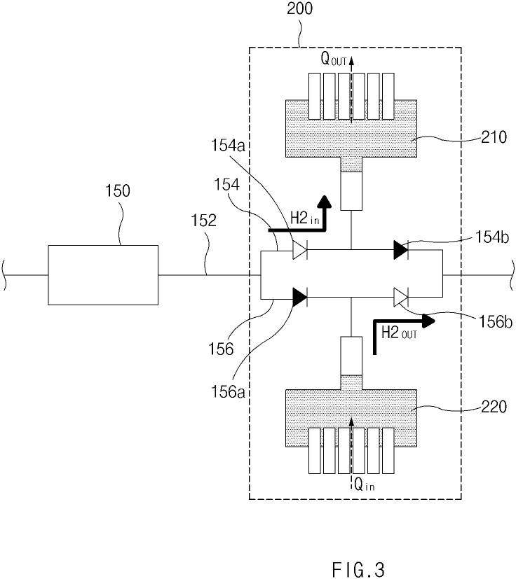

According to an exemplary embodiment of the present disclosure, the reforming part 100 may include: a reformer 130 configured to produce a target gas containing hydrogen by allowing the source gas to react with water; a burner 160 configured to apply heat to the reformer 130; and a pressure swing adsorption (PSA) unit 150 configured to separate hydrogen from the target gas discharged from the reformer 130. The metal hydride compressor 200 may be operated by heat (Qin in FIGS. 2 and 3) of an exhaust gas discharged from the burner 160.

The reformer 130 refers to a device for producing the target gas containing hydrogen by allowing the source gas (e.g., LNG) to react with water.

For example, a chemical reaction in the reformer 130 in which the reforming reaction occurs may be expressed as the following Chemical Formula 1.

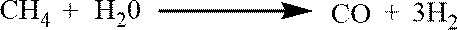

Various reformers capable of producing the target gas may be used as the reformer 130. The present disclosure is not restricted or limited by the type and structure of the reformer 130.

For example, the reformer 130 may include a reactor 132 in which the source gas reacts with the water, and a refiner (water gas shift (WGS)) 134 configured to refine the target gas produced by the reactor 132.

The burner 160 serves to apply heat to the reformer 130. That is, the steam reforming reaction is a highly endothermic reaction. Therefore, the burner 160 serves to supply reaction heat to the reformer 130 so that a forward reaction may actively occur under a high-temperature condition.

The burner 160 may have various structures capable of applying heat to the reformer 130 by combusting a fuel gas. The present disclosure is not restricted or limited by the type and structure of the burner 160.

The pressure swing adsorption (PSA) unit 150 serves to separate the hydrogen from the target gas discharged from the reformer 130.

Various separation facilities capable of separating the hydrogen from the target gas may be used as the PSA unit 150. The present disclosure is not restricted or limited by the type and treatment method of the PSA unit 150.

For example, the PSA unit 150 may separate the hydrogen from the target gas on the basis of low-temperature distillation, membrane separation, adsorption, and the like.

The metal hydride compressor 200 is operated by waste heat discharged from the reforming part 100 and serves to compress the hydrogen discharged from the reforming part 100, before supplying the hydrogen to a supply destination (e.g., a high-pressure tank).

For reference, in an example embodiment of the present disclosure, the metal hydride compressor 200 may be defined as a metal hydride compressor that does not include a separate heat source (e.g., a heater and a tube) for heating.

The metal hydride compressor 200 is a metal hydride-based thermal compressor and may compress the hydrogen through a process of repeatedly heating and cooling the hydrogen by using properties of the metal hydride material.

The metal hydride compressor 200 may have various structures and shapes having a storage space therein. The present disclosure is not restricted or limited by the structure and shape of the metal hydride compressor 200.

For reference, the metal hydride material constituting the metal hydride compressor 200 may be variously changed in type in accordance with required conditions and design specifications.

For example, the metal hydride material may include at least any one of lanthanum (La), zirconium (Zr), titanium (Ti), calcium (Ca), and magnesium (Mg) and at least any one of nickel (Ni), copper (Cu), zinc (Zn), iron (Fe), cobalt (Co), manganese (Mn), and vanadium (V). For example, the metal hydride may be any one or more substances selected from LaNis, CaCus, MgZn₂, ZrNi₂, TiFe, TiCo, Mg₂Ni, TiMn₂, and Mg₂Cu.

According to an exemplary embodiment of the present disclosure, the metal hydride compressor 200 is operated by the waste heat discharged from the reforming part 100. The waste heat discharged from the reforming part 100 may be defined as heat of the exhaust gas discharged from the burner 160.

That is, the metal hydride compressor 200 may be operated by heat (see Qin in FIGS. 2 and 3) of the exhaust gas discharged from the burner 160.

For example, the hydrogen reforming system 10 may include an exhaust gas discharge line 162 configured to discharge the exhaust gas generated by combusting fuel (e.g., source gas) in the burner 160, and an exhaust gas guide line 210 connected to the exhaust gas discharge line 162 and configured to guide the exhaust gas to the metal hydride compressor 200. The exhaust gas supplied along the exhaust gas guide line 210 may be used as a heat medium for heating the metal hydride compressor 200.

For example, the exhaust gas discharged from the burner 160 may have a temperature of approximately 1,000° C. or higher. The temperature of the exhaust gas supplied to the metal hydride compressor 200 via a heater 120 and an air heat exchanger 170 may be approximately 100° C.

For reference, the exhaust gas guide line 210 may be connected to the metal hydride compressor 200 by means of various structures capable of heating the metal hydride compressor 200. The present disclosure is not restricted or limited by the connection structure between the exhaust gas guide line 210 and the metal hydride compressor 200. For example, the exhaust gas guide line 210 may pass through the interior of the metal hydride compressor 200 or surround the metal hydride compressor 200.

The metal hydride compressor 200 may have various structures capable of compressing the hydrogen.

Referring to FIGS. 2 and 3, the metal hydride compressor 200 according to an exemplary embodiment of the present disclosure may include a first compressor configured to compress the hydrogen and disposed in a first branch line branching off from a hydrogen discharge line 152 through which the hydrogen is discharged from the reforming part 100 (a hydrogen discharge line connected to the PSA unit), and a second compressor configured to compress the hydrogen alternately with the first compressor and disposed in a second branch line 156 branching off from the hydrogen discharge line 152 and connected in parallel with the first branch line.

In addition, the first branch line may be provided with a first inlet valve 154a configured to block and permit a supply of the hydrogen to the first compressor, and a first outlet valve 154b configured to block and permit a discharge of the hydrogen from the first compressor. Likewise, the second branch line 156 may be provided with a second inlet valve 156a configured to block and permit a supply of the hydrogen to the second compressor, and a second outlet valve 156b configured to block and permit a discharge of the hydrogen from the second compressor.

Referring to FIG. 2, as the first compressor is heated (Qin) (the waste heat discharged from the reforming part is applied to the first compressor in a state in which the first inlet valve 154a is closed and the first outlet valve 154b is opened, the first compressor may compress the hydrogen, and the hydrogen compressed by the first compressor may be discharged (H2ₒᵤₜ) to the supply destination through the first outlet valve 154b. In contrast, the second inlet valve 156a may be opened, the second outlet valve 156b may be closed, the second compressor may be cooled (Qₒᵤₜ), and the hydrogen discharged from the reforming part 100 may be supplied to the second compressor while the first compressor compresses the hydrogen.

On the contrary, referring to FIG. 3, as the second compressor is heated (Qin) (the waste heat discharged from the reforming part is applied to the second compressor) in a state in which the second inlet valve 156a is closed and the second outlet valve 156b is opened, the second compressor may compress the hydrogen, and the hydrogen compressed by the second compressor may be discharged (H2ₒᵤₜ) to the supply destination through the second outlet valve 156b. In contrast, the first inlet valve 154a may be opened, the first outlet valve 154b may be closed, the first compressor may be cooled (Qout), and the hydrogen discharged from the reforming part 100 may be supplied to the first compressor while the second compressor compresses the hydrogen.

As described above, the first compressor and the second compressor may be connected in parallel with each other, and the first compressor and the second compressor may alternately compress the hydrogen, which makes it possible to continuously perform the process of compressing the hydrogen without interruption.

In the example embodiment of the present disclosure illustrated and described above, the example has been described in which the metal hydride compressor 200 includes the first compressor and the second compressor connected in parallel with each other. However, according to another exemplary embodiment of the present disclosure, three or more compressors may be used to constitute the metal hydride compressor. The present disclosure is not restricted or limited by the number of compressors and the arrangement structure of the compressors.

In addition, in the example embodiment of the present disclosure illustrated and described above, the example has been described in which the metal hydride compressor 200 includes the plurality of compressors (the first compressor and the second compressor) connected in parallel with each other and continuously performs the process of compressing the hydrogen. However, according to another example embodiment of the present disclosure, only the single metal hydride compressor may be provided, and the process of compressing the hydrogen may be intermittently performed.

According to an exemplary embodiment of the present disclosure, the hydrogen reforming system 10 may include the heater 120 disposed in a source gas supply line for supplying the source gas to the reformer 130 and configured to heat the source gas. The exhaust gas discharge line 162 may pass through the heater 120, and the exhaust gas may be used as a heat medium for the heater 120.

For example, the exhaust gas discharged from the burner 160 may have a temperature of approximately 1,000° C. or higher. The temperature of the exhaust gas having passed through the heater 120 may be approximately 400° C.

Since the exhaust gas discharge line 162 passes through the heater 120 as described above, the exhaust gas may be used as the heat medium for the heater 120. Therefore, it is possible to obtain an advantageous effect of minimizing consumption of the electric power of the heater 120 for heating the source gas and improving the energy efficiency.

According to an exemplary embodiment of the present disclosure, the hydrogen reforming system 10 may include a desulfurizer 110 disposed in the source gas supply line and positioned at an upstream side from the heater 120.

The desulfurizer 110 serves to refine a sulfur compound contained in the source gas before the source gas is supplied to the reformer 130.

A typical desulfurizer capable of refining the sulfur compound contained in the source gas may be used as the desulfurizer 110. The present disclosure is not restricted or limited by the type and desulfurization method of the desulfurizer 110. For example, the desulfurizer 110 may refine the sulfur compound contained in the source gas by using a hydrodesulfurization (HDS) method or refine the sulfur compound contained in the source gas by using an adsorption method using an adsorbent (e.g., activated carbon, silica gel, or zeolite).

In addition, according to an exemplary embodiment of the present disclosure, the hydrogen reforming system 10 may include an air supply line 164 configured to supply air to the burner 160, and the air heat exchanger 170 disposed in the exhaust gas discharge line 162 and configured to allow the exhaust gas and the air to exchange heat with each other.

Since the air (e.g., the air at room temperature) supplied along the air supply line 164 exchanges heat with the exhaust gas (the exhaust gas having passed through the heater and having a temperature of approximately 400° C.) as described above, the air to be supplied to the burner 160 may be heated to approximately 300° C. Therefore, it is possible to obtain an advantageous effect of further improving the efficiency and performance of the burner 160.

Meanwhile, in the exemplary embodiment of the present disclosure illustrated and described above, the example has been described in which the metal hydride compressor 200 is operated by the heat of the exhaust gas discharged from the burner 160. However, according to another exemplary embodiment of the present disclosure, the metal hydride compressor may be operated by other waste heat discharged from the reforming part.

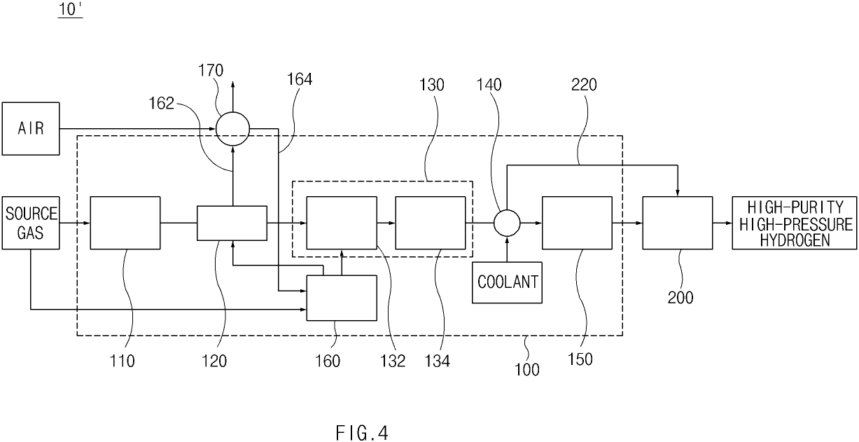

FIG. 4 is a view for explaining a hydrogen reforming system according to another exemplary embodiment of the present disclosure. Further, the parts identical and equivalent to the parts in the above-mentioned configuration will be designated by the identical or equivalent reference numerals, and detailed descriptions thereof will be omitted.

Referring to FIG. 4, according to another exemplary embodiment of the present disclosure, a hydrogen reforming system 10′ may include a reforming part 100 and a metal hydride compressor 200. The reforming part 100 may include: a reformer 130 configured to produce a target gas containing hydrogen by allowing a source gas to react with water; a burner 160 configured to apply heat to the reformer 130; a target gas discharge line configured to discharge the target gas from the reformer 130; a pressure swing adsorption (PSA) unit 150 connected to the target gas discharge line and configured to separate the hydrogen from the target gas; and a heat exchanger 140 disposed in the target gas discharge line to allow a coolant to flow and configured to allow the target gas and the coolant (e.g., water) to exchange heat with each other. The metal hydride compressor 200 may be operated by heat (see Qin in FIGS. 2 and 3) of the coolant having passed through the heat exchanger 140.

That is, the metal hydride compressor 200 may be operated by heat of the coolant that cools the target gas before the target gas discharged from the reformer 130 is supplied to the PSA unit 150.

For example, the hydrogen reforming system 10′ may include a coolant guide line 220 connected to the heat exchanger 140 and configured to guide the coolant having passed through the heat exchanger 140 to the metal hydride compressor 200. The coolant supplied along the coolant guide line 220 may be used as a heat medium for heating the metal hydride compressor 200.

For example, since the coolant (e.g., the coolant at room temperature) supplied to the heat exchanger 140 exchanges heat with the target gas, a temperature of the coolant to be supplied to the metal hydride compressor 200 may be approximately 130° C.

For reference, the coolant guide line 220 may be connected to the metal hydride compressor 200 by means of various structures capable of heating the metal hydride compressor 200. The present disclosure is not restricted or limited by the connection structure between the coolant guide line 220 and the metal hydride compressor 200. For example, the coolant guide line 220 may pass through the interior of the metal hydride compressor 200 or surround the metal hydride compressor 200.

According to an exemplary embodiment of the present disclosure, the hydrogen reforming system 10′ may include an exhaust gas discharge line 162 configured to discharge the exhaust gas generated by the combustion of the fuel (e.g., source gas) in the burner 160, and a heater 120 disposed in a source gas supply line for supplying the source gas to the reformer 130 and configured to heat the source gas. The exhaust gas discharge line 162 may pass through the heater 120, and the exhaust gas may be used as a heat medium for the heater 120.

In addition, according to an exemplary embodiment of the present disclosure, the hydrogen reforming system 10′ may include a desulfurizer 110 disposed in the source gas supply line and positioned at an upstream side from the heater 120.

According to an example embodiment of the present disclosure described above, it is possible to simplify the structure and improve the energy efficiency.

In particular, according to an exemplary embodiment of the present disclosure, it is possible to extract the high-pressure hydrogen directly from the hydrogen reforming system without additionally using a separate compressor.

Among other things, according to an exemplary embodiment of the present disclosure, it is possible to operate the metal hydride compressor by using the waste heat discharged from the reforming part without additionally providing a separate heat source for operating the metal hydride compressor.

In addition, according to an exemplary embodiment of the present disclosure, it is possible to obtain an advantageous effect of minimizing the electric power consumption and improving the energy efficiency.

In addition, according to an exemplary embodiment of the present disclosure, it is possible to obtain an advantageous effect of simplifying the structure and improving the degree of design freedom and spatial utilization.

While exemplary embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A hydrogen reforming system comprising:
a reforming part configured to extract hydrogen from a source gas; and
a metal hydride compressor configured to be operated by waste heat discharged from the reforming part and to compress the hydrogen discharged from the reforming part.

2. The hydrogen reforming system of claim 1, wherein the reforming part comprises:
a reformer configured to produce a target gas comprising the hydrogen by allowing the source gas to react with water;
a burner configured to apply heat to the reformer; and
a pressure swing adsorption (PSA) unit configured to separate the hydrogen from the target gas discharged from the reformer, and
wherein the metal hydride compressor is operated by heat of an exhaust gas discharged from the burner.

3. The hydrogen reforming system of claim 2, comprising:
an exhaust gas discharge line configured to discharge the exhaust gas from the burner; and
an exhaust gas guide line connected to the exhaust gas discharge line and configured to guide the exhaust gas to the metal hydride compressor.

4. The hydrogen reforming system of claim 3, comprising:
a heater disposed in a source gas supply line for supplying the source gas to the reformer and configured to heat the source gas,
wherein the exhaust gas discharge line passes through the heater, and the exhaust gas is used as a heat medium for the heater.

5. The hydrogen reforming system of claim 4, comprising:
a desulfurizer disposed in the source gas supply line and positioned at an upstream side from the heater.

6. The hydrogen reforming system of claim 3, comprising:
an air supply line configured to supply air to the burner; and
an air heat exchanger disposed in the exhaust gas discharge line and configured to allow the exhaust gas and the air to exchange heat with each other.

7. The hydrogen reforming system of claim 1, wherein the reforming part comprises:
a reformer configured to produce a target gas containing the hydrogen by allowing the source gas to react with water;
a burner configured to apply heat to the reformer;
a target gas discharge line configured to discharge the target gas from the reformer;
a pressure swing adsorption (PSA) unit connected to the target gas discharge line and configured to separate the hydrogen from the target gas; and
a heat exchanger disposed in the target gas discharge line to allow a coolant to flow and configured to allow the target gas and the coolant to exchange heat with each other, and
wherein the metal hydride compressor is operated by heat of the coolant having passed through the heat exchanger.

8. The hydrogen reforming system of claim 7, comprising:
a coolant guide line connected to the heat exchanger and configured to guide the coolant having passed through the heat exchanger to the metal hydride compressor.

9. The hydrogen reforming system of claim 7, comprising:
an exhaust gas discharge line configured to discharge an exhaust gas from the burner; and
a heater disposed in a source gas supply line for supplying the source gas to the reformer and configured to heat the source gas,
wherein the exhaust gas discharge line passes through the heater, and the exhaust gas is used as a heat medium for the heater.

10. The hydrogen reforming system of claim 9, comprising:
a desulfurizer disposed in the source gas supply line and positioned at an upstream side from the heater.

11. The hydrogen reforming system of claim 1, wherein the metal hydride compressor comprises:
a first compressor configured to compress the hydrogen and disposed in a first branch line branching off from a hydrogen discharge line through which the hydrogen is discharged from the reforming part; and
a second compressor configured to compress the hydrogen alternately with the first compressor and disposed in a second branch line branching off from the hydrogen discharge line and connected in parallel with the first branch line.
